(19) United States
(12) Patent Application Publication
(10) Pub. No.: US 2005/0258638 A1
(43) Pub. Date: Nov. 24, 2005

(54) Reducing a book's resale value

(76) Inventor: Daniel J. Morton, Paris (FR)

Correspondence Address: John G. Posa;Gifford, Krass, Groh, Sprinkle, Anderson & Citkowski, P.C., 280 N. Old Woodward Ave., Suite 400, Birmingham, MI, 48009-5394, US

(21) Appl. No.: 10/852,414

(22) Filed: May 24, 2004

(51) Int. Cl. B42D 1/00

(52) U.S. Cl. 283/105

(57) ABSTRACT

A book owner is given an offer or incentive to alter a book in a way that will minimize and, ideally, eliminate the potential for resale. In the preferred embodiment, the cover of the book includes a mail-in card associated with a sweepstakes, such that by cutting out the card and entering into the drawing, the user effectively relinquishes the ability to resell the book. As opposed to removing the cover, or a portion of the cover, alternative embodiments include sending in one or more pages of the book, either as part of a chapter or randomly extracted, or otherwise altering the text so as to dramatically minimize or eliminate its resale value.

### FIELD OF THE INVENTION

This invention relates generally to the publishing industry and, in particular, to method and articles whereby the user a book may reduce its resale value to increase publisher revenues.

### BACKGROUND OF THE INVENTION

The reselling of books such as textbooks is not only legal, it is widespread. Although this practice may be somewhat beneficial to book users, such as students, and perhaps to the stores that sell used books, it causes publishers to incur losses which are substantial in some cases.

The current options available to publishers to discourage or minimize the used book trade are few and, for the most part, undesirable. In the case of textbooks, for example, it is not uncommon for publishers to come out with new editions on a regular basis, thereby forcing students to obtain a new edition for a particular course. While this practice is suitable for subject matter which might change on a regular basis, such as legal textbooks, art, new media, and so forth, it is less applicable to publishers of textbooks involving subject matter that either does not change, or does not change that often. Examples here include engineering, mathematics, learning a language, and so forth.

As it happens, book stores and other outlets will not resell a book if it is significantly altered. Whereas underlining and highlighting and the like are generally acceptable, torn pages, missing covers, and so forth, are not. There are several reasons for this. One is that potential purchasers are not likely to pay a very high price for a book that is significantly altered, making it economically undesirable for a book store to carry it. But in addition, and perhaps more importantly, one of the ways that book sellers “get credit” for books that did not sell, is to remove the cover and send it back to the publisher. Generally, this includes the return of the portion of the book including the ISBN number, but in any case, having done this, the book store is obligated to destroy the book itself without selling it.

Given these industry practices, the need remains for methods and articles to help protect publishers against losses incurred through used book sales while, at the same time, giving a book owner an alternative incentive to alter a book as opposed to reselling it.

### SUMMARY OF THE INVENTION

Broadly, this invention resides in methods and articles whereby a book owner is given an offer or incentive to alter a book in a way that will minimize and, ideally, eliminate the potential for resale. In the preferred embodiment, the cover of the book includes a mail-in card associated with a sweepstakes, such that by cutting out the card and entering into the drawing, the user effectively relinquishes the ability to resell the book. As opposed to removing the cover, or a portion of the cover, alternative embodiments include sending in one or more pages of the book, either as part of a chapter or randomly extracted, or otherwise altering the text so as to dramatically minimize or eliminate its resale value.

### BRIEF DESCRIPTION OF THE DRAWINGS

FIG. 1A is a drawing that depicts a preferred embodiment of the invention involving a mail-in card forming part of a book's cover;

FIG. 1B is a drawing of the book of FIG. 1A with the card detached;

FIG. 2A depicts an alternative embodiment of the invention, whereas a user is encouraged to remove at least a portion of a chapter of a book;

FIG. 2B is a drawing which shows a chapter being removed and placed into an envelope;

FIG. 3A is a drawing that shows yet a further alternative embodiment of the invention, wherein pages are randomly removed from a book; and

FIG. 3B shows the random pages being mailed in as part of an offer for incentive.

### DETAILED DESCRIPTION OF THE INVENTION

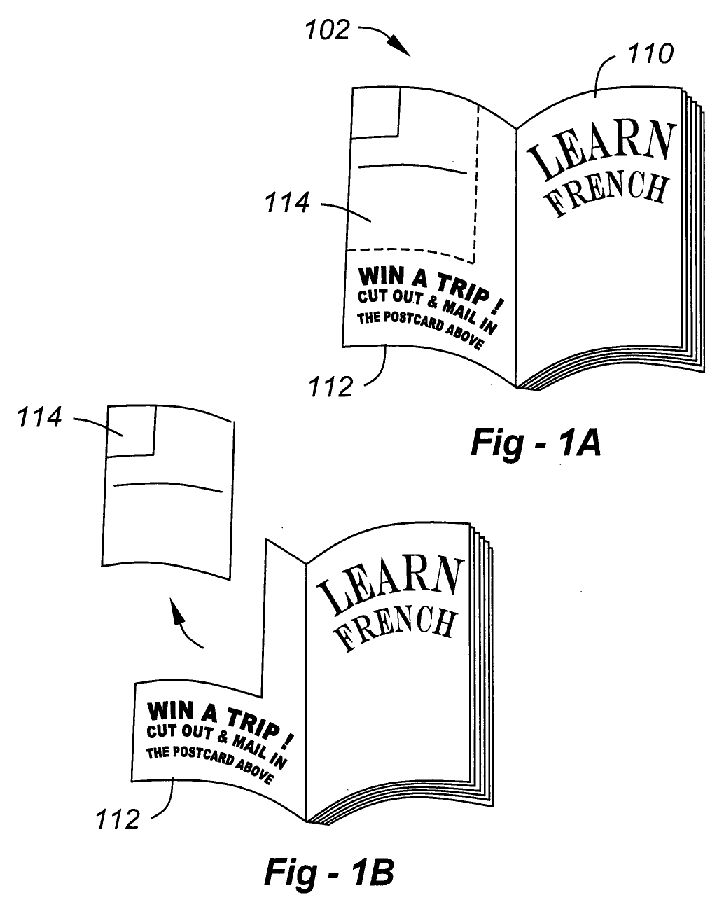

FIGS. 1A and 1B depict generally at 102 a preferred embodiment of the invention, wherein the owner of a book 110 is encouraged to remove at least a portion 114 of the book's cover 112, and to mail it to a location as proof that the act was carried out. Preferably, in return for altering the book in this or other ways described therein, the book owner is given an offer or incentive to encourage the modification. For example, the mail-in card may be involved in some sort of drawing or sweepstakes. Alternatively, the sender might be given a monetary rebate or coupon, a reduction in price on the next edition of the book, a less expensive or even free other book, or other products.

Although the card 114 is shown as part of the front cover, consuming only a portion of a soft-cover book, the invention is not limited in this regard, as the entire cover may be involved, a back cover or portion thereof may be involved, and hard covers as opposed to soft covers may be used. In the case of a language book, advantageously, the card 114 may be associated with winning a trip to a country associated with the language being learned, for example. FIG. 1B is a drawing which shows the card 114 having been removed from the cover 112 for mailing, thereby rendering the book virtually unsellable.

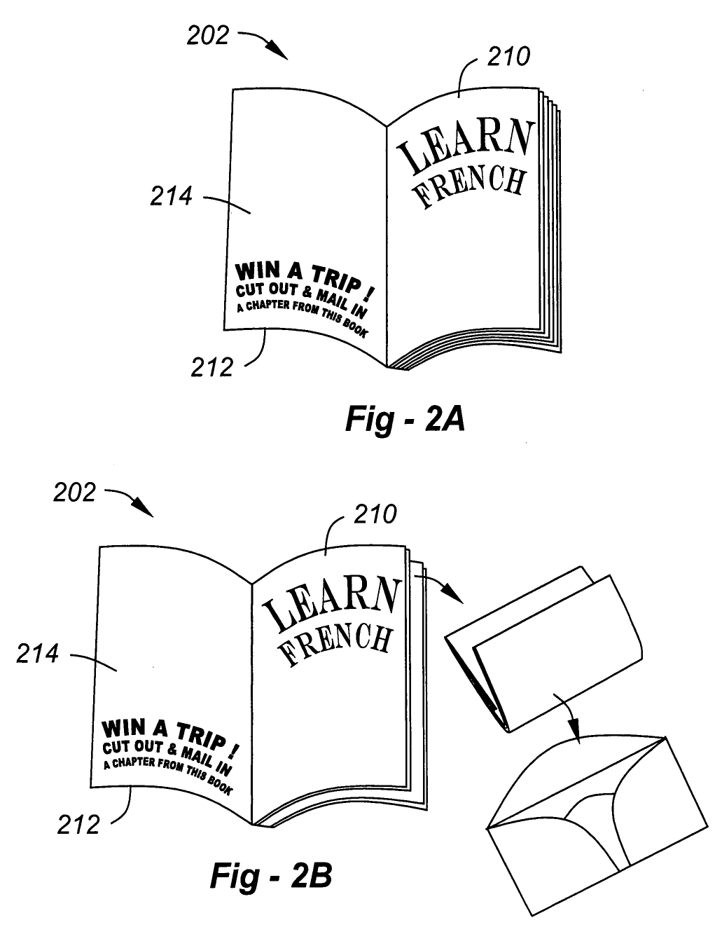

FIG. 2A is a drawing which shows an alternative embodiment of the invention, depicted generally at 202, wherein a cover 212 includes instructions 214 (not all of which are shown), encouraging the owner to remove a chapter from the book, or a number of consecutive pages, and place it in an envelope (which may be provided in the book and self-addressed and self-stamped), an action which is shown in FIG. 2B. Again, in return for this proof of alteration, the owner will preferably be given some sort of incentive, whether as part of a drawing, monetary, or otherwise.

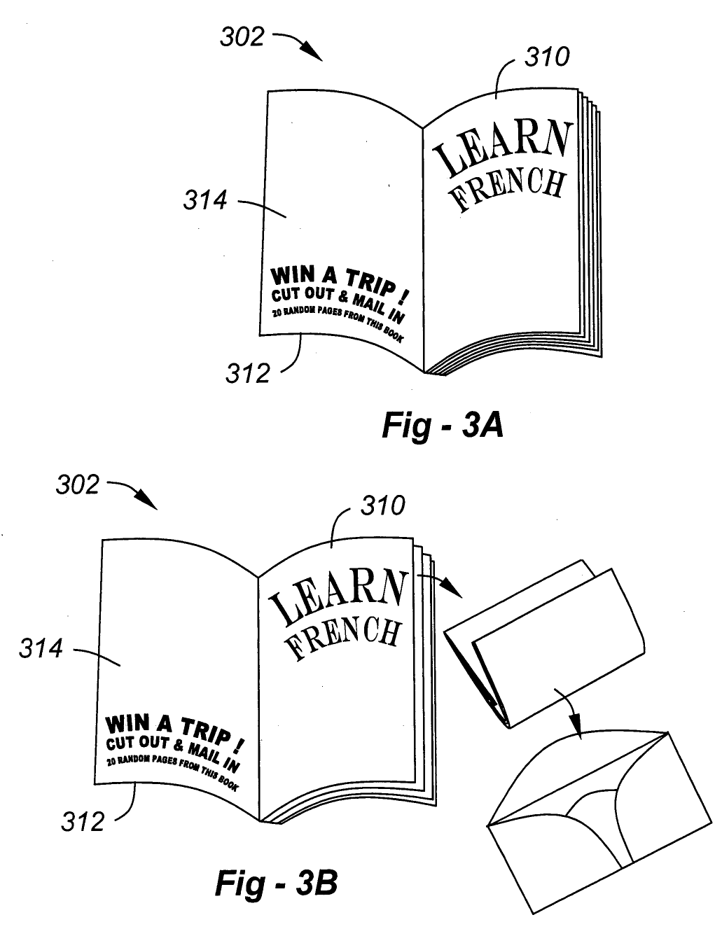

FIGS. 3A and 3B depicts yet a further alternative embodiment of the invention, depicted at 302, wherein a book 310 includes a cover 312 with instructions requesting that the owner remove one or pages at random from the book, and place them in an envelope as shown in FIG. 3B. Again, a self-addressed, postage-paid envelope may be provided in the book.

Although specific embodiments of the invention have been depicted herein, other less attractive alternatives are possible, including cutting, burning, or tearing at least a portion of the book, and perhaps using a digital camera to verify the action. This would allow a photograph to either be sent through the mail or attached as part of an e-mail without the need for postage. A short “movie” proving an alteration may alternatively be used.

1. A method of reducing the re-sale value of a book, comprising the steps of:
providing a book including directions for removing or destroying the book or a portion thereof;
following the directions; and
submitting proof to a third party that the book or a portion thereof was altered in accordance with the directions.

2. The method of claim 1, wherein the book is altered by the cover or a portion thereof.

3. The method of claim 2, wherein the removed portion is a mail-in card.

4. The method of claim 3, wherein the mail-in card is used to receive an incentive.

5. The method of claim 4, wherein the incentive is an entry into a drawing or sweepstakes.

6. The method of claim 4, wherein the incentive is a rebate.

7. The method of claim 4, wherein the incentive is a coupon.

8. The method of claim 1, wherein the book is altered by removing one or more pages of the book.

9. A book altered according to the method of claim 1.

10. A method of reducing the re-sale value of a book, comprising the steps of:
providing a book with a cover including a mail-in card; and
removing the card to receive an incentive.

11. The method of claim 4, wherein the incentive is an entry into a drawing or sweepstakes.

12. The method of claim 4, wherein the incentive is a rebate.

13. The method of claim 4, wherein the incentive is a coupon.

14. A book according to claim 10.
